(19) United States
(12) Patent Application Publication
(10) Pub. No.: US 2014/0313929 A1
(43) Pub. Date: Oct. 23, 2014

(54) ENABLING DEVICES TO DISCOVER SERVICES THROUGH A NETWORK CONTROLLER OR GROUP OWNER

(71) Applicants: Emily H. Qi, Portland, OR (US); Bahareh Sadeghi, Portland, OR (US)

(72) Inventors: Emily H. Qi, Portland, OR (US); Bahareh Sadeghi, Portland, OR (US)

(21) Appl. No.: 13/948,634

(22) Filed: Jul. 23, 2013

Related U.S. Application Data
(60) Provisional application No. 61/813,046, filed on Apr. 17, 2013.

(51) Int. Cl. H04W 48/08; H04W 52/02

(52) U.S. Cl. CPC H04W 48/08; H04W 52/0212
USPC 370/254

(57) ABSTRACT

Techniques are described that permit a STA to determine if one or more particular services are available from other devices in a particular network, without having to first associate with that network. This may be accomplished by having the network controller obtain and maintain a list of services provided by all of the associated devices in the network. An unassociated device may provide a list of services it is looking for in a Probe Request. In the Probe Response, the network controller can provide a list of the requested services that are actually available from devices in its network. This permits the unassociated device to determine if this network has the services it needs, without having to first become associated with that network.

### CROSS REFERENCE TO RELATED APPLICATIONS

This application is derived from U.S. provisional patent application Ser. No. 61/813,046, filed Apr. 17, 2013, and claims priority to that filing date for all applicable subject matter.

### BACKGROUND

In wireless communication networks in which services are provided by multiple wireless devices, any particular wireless device may employ service discovery techniques to become aware of services provided by the other wireless devices in the wireless network, provided that the device initiating service discovery is already associated with that network. A device seeking one or more particular services may have several networks within range that it can associate with, but may be unaware which, if any, of those networks has the services it seeks. The device may have to become associated with each available network in turn before it can determine if that particular network has any device with any of the services it seeks. This process can waste a lot of time, network resources, and battery power by associating and disassociating with networks that cannot provide the needed services.

### BRIEF DESCRIPTION OF THE DRAWINGS

Some embodiments of the invention may be better understood by referring to the following description and accompanying drawings that are used to illustrate embodiments of the invention. In the drawings:

FIG. 1 shows a network, according to an embodiment of the invention.

FIG. 2 shows a wireless communications device, according to an embodiment of the invention.

FIG. 3 shows a management frame which can be used for communicating the services information, according to an embodiment of the invention.

FIG. 4 shows various fields in an Association Request frame, Reassociation Request frame, or Action frame, according to an embodiment of the invention.

FIG. 5 shows various fields in a Probe Request frame, according to an embodiment of the invention.

FIG. 6 shows various fields in a Probe Response frame, according to an embodiment of the invention.

FIG. 7 shows a flow diagram of a method of communicating about services, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “wireless” may be used to describe circuits, devices, systems, methods, techniques, communications channels, etc., that communicate data by using modulated electromagnetic radiation through a non-solid medium. A wireless device may comprise at least one antenna, at least one radio, at least one memory, and at least one processor, where the radio(s) transmits signals through the antenna that represent data and receives signals through the antenna that represent data, while the processor(s) may process the data to be transmitted and the data that has been received. The processor(s) may also process other data which is neither transmitted nor received.

As used within this document, the term “network controller” is intended to cover devices that schedule and control, at least partially, wireless communications by other devices in the network. A network controller may also be known as a base station (BS), access point (AP), central point (CP), or any other term that may arise to describe the functionality of a network controller.

As used within this document, the term “STA” is intended to cover those devices whose wireless communications are at least partially scheduled and controlled by the network controller. This definition also includes devices that are not yet associated with a network controller (and the device's communication activities are therefore not yet scheduled and controlled), but is seeking such an association. A STA may also be known as a mobile station (MS), Mobile Device (MD), subscriber station (SS), user equipment (UE), or any other term that may be used to describe the functionality of a STA. Some STAs may move during such communications, but movement is not required.

As used within this document, the term “communicate” and its derivatives are intended to include transmitting and/or receiving. This may be particularly useful in claims when describing the organization of data that is being transmitted by one device and received by another, but only the functionality of one of those devices is required to infringe the claim. Similarly, the bidirectional exchange of data between a network controller and a mobile device (both devices transmit and receive during the exchange) may be described as ‘communicating’, even though the functionality of only one of those devices is being claimed.

Various embodiments of the invention pertain to providing ways for a network controller to advertise the services provided by the associated devices in its network. This technique permits STAs that are not associated to determine if this network has the desired services without having to first become associated with that network.

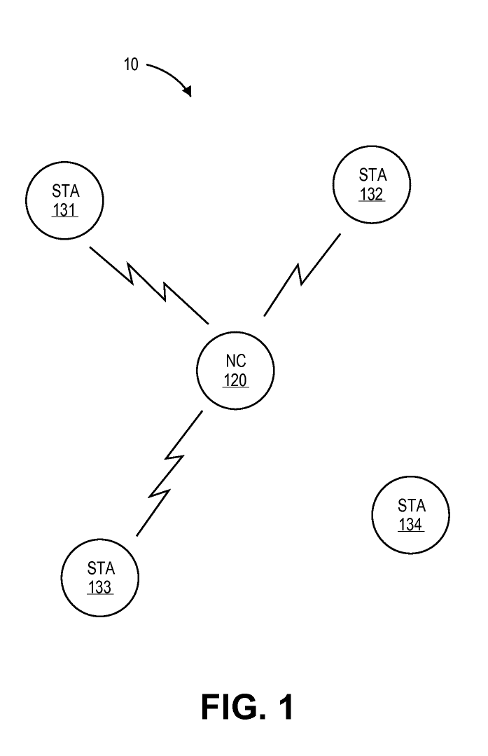

FIG. 1 shows a network, according to an embodiment of the invention. In network 10, network controller (NC) 120 may control the overall communications between itself and the various STAs 131-133 that are associated with NC 120. Although three STAs are shown, a network may contain more or fewer STAs. FIG. 1 also shows a fourth STA 134, which is not associated with NC 120 (and therefore not currently part of the network), but nevertheless may communicate with NC 120 under certain limited circumstances

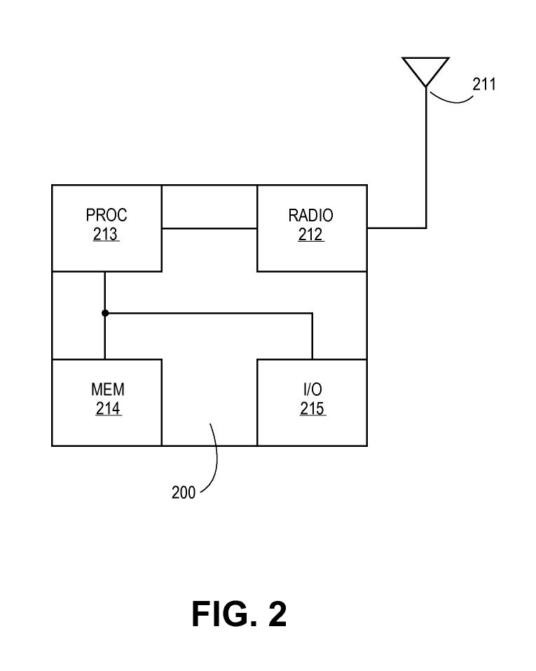

FIG. 2 shows a wireless communications device, according to an embodiment of the invention. The illustrated components of this wireless device 200 may be found in many types of wireless devices, such as but not limited to NC 120 or STA 131, 132, 133, or 134. This wireless device is shown with one or more antennas 211, one or more radios 212, one or more processors 213, one or more memories 214, and one or more user interfaces 215. In some embodiments, memory 214 may contain instructions which, when executed by processor 213, may cause performance of the various operations described herein. These components may be coupled together in any feasible manner

One or more of the STAs 131-133 may provide services that can be used by other STAs in the network. For example, such services may include one or more of, but are not limited to: 1) use of a specialized printer or other peripheral, 2) a database of specific information, such as a music library, 3) specific software modules for downloading, 4) etc.

Before an NC can advertise the services available from the STAs in its network, it may need to find out what those services are. In one embodiment, it can learn this information during the association process. For example, during the association process with a wireless network controller, a STA may provide the network controller with a service identifier (Service ID) for each service that the STA supports and wants to be advertised. Based on this information from one or more STAs, the NC may generate and maintain a cumulative list of all the services available from all the STAs in the network. This cumulative list may be updated as STAs enter or leave the network. This cumulative list may also be updated when an individual STA changes the service(s) it provides. The individual STA may change its offered services by transmitting a Reassociation frame or an Action frame identifying its new list of offered services.

When a STA is searching for available services in a network in which it is not associated, it may specify the services it seeks in a Probe Request frame. The NC may then compare this list with the services currently being offered in the network, and transmit a Probe Response frame to notify the STA of the services that are both 1) being sought by the STA, and 2) are available in the network. The STA may then make a decision about whether to become associated with this network.

If the STA decides to become associated with this network, and it has services of its own to offer, it may specify those services in the association process as described above, and the NC may add those services to its cumulative list of services being offered in the network.

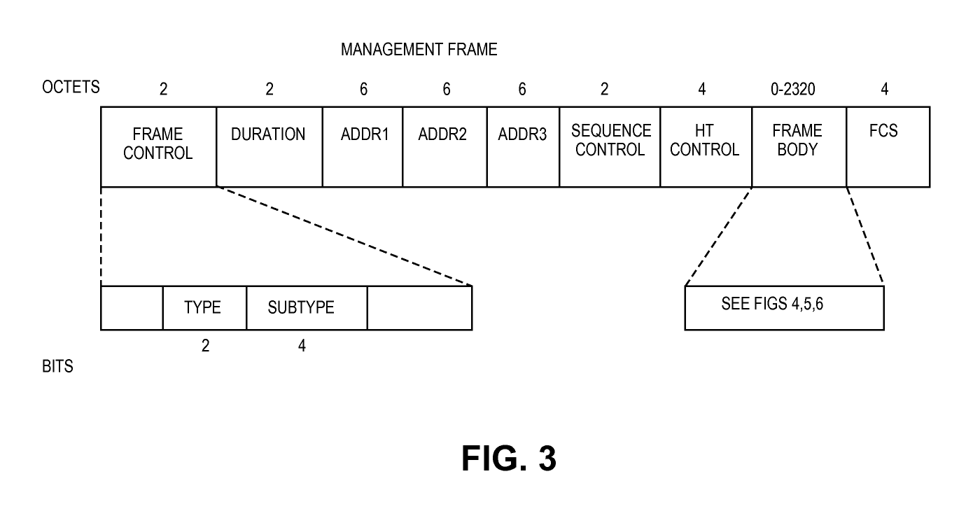

FIG. 3 shows a management frame which can be used for communicating the services information, according to an embodiment of the invention. The top row shows a format for a general purpose frame. In some embodiments, the Frame Control field may include a 2-bit Type field to specify whether this is a management frame (00), or some other type of frame. The Frame Control field may also include a 4-bit field to indicate the sub-type of the management frame, such as an Association Request (0000), Association Response (0001), Reassociation Request (0010), Reassociation Response (0011), Probe Request (0100), Probe Response (0101), Disassociation (1010), or Action frame (1101). These values and field sizes are given as examples for particular embodiments, but other values and field sizes may be used instead.

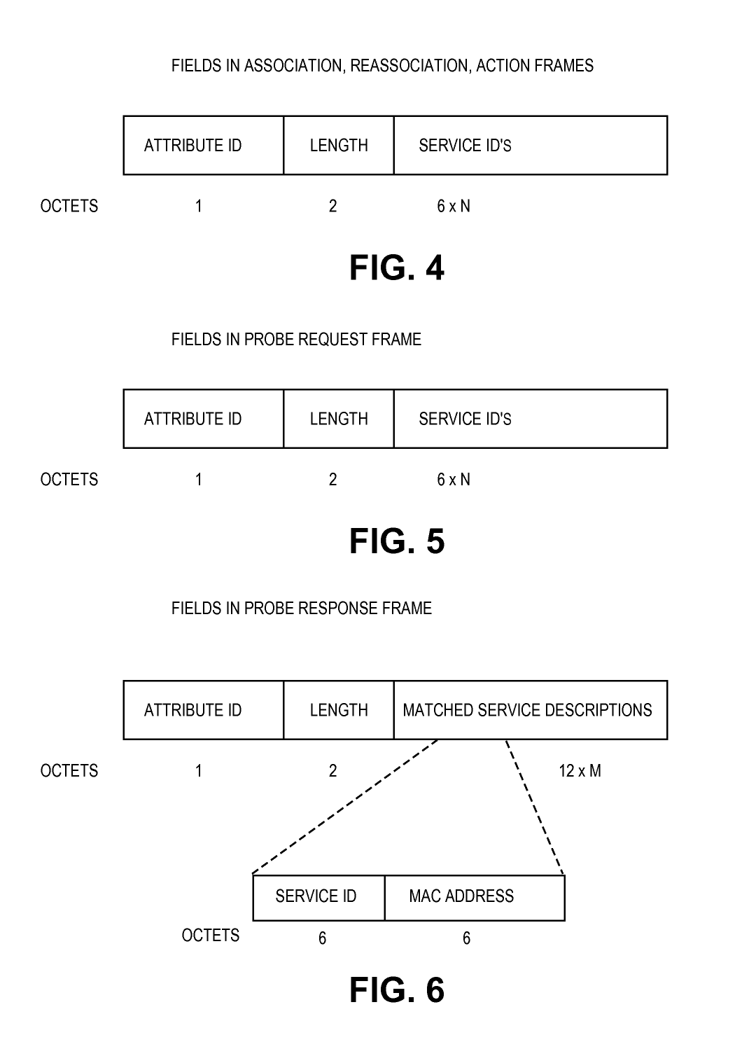

In some embodiments, the Frame Body field may be used to indicate further information. The particular format and values may depend on which type of frame/sub-frame was indicated in the Frame Control Field. FIGS. 4, 5, and 6 show examples of various formats that may be used in the Frame Body field.

In some embodiments, the list of services available from a particular STA may be provided by the STA when the STA requests association by transmitting an Association Request frame to the NC. This may be accomplished by including one or more Service IDs in the Association Request, where each Service ID is an indicator of a particular service. The mapping between Service IDs and particular services may be predetermined in various ways, for example by being defined in an industry standard.

In a similar manner, a device that is already associated with the NC may update its list of available services by transmitting a Reassociation Request or an Action frame, which includes the updated list of Service IDs.

An unassociated STA may inquire what services are available in a network by transmitting a Probe Request to the NC of that network, with the Probe Request including a list of Service IDs being sought.

An NC that receives such a Probe Request may transmit a Probe Response to the inquiring STA, with the Probe Response including a list of Service IDs that are both 1) being requested by the STA, and 2) are available in the network.

FIG. 4 shows various fields in an Association Request frame, Reassociation Request frame, or Action frame, according to an embodiment of the invention. In the illustrated example, the various fields shown in the drawing may be located in the Frame Body field of the frame. In this embodiment, the Attribute ID field may indicate that the following fields identify the services that are available through this particular STA. The Length field may be used to find the end of these fields, so that any subsequent data will not be interpreted as part of this service information. For example, the Length field may indicate the length of the Service Hashes field. The Service Hashes field may list the services that this STA is able and willing to provide. In the illustrated example, the Attribute ID field may be 1 octet in length, the Length field may be 2 octets in length, and the Service Hashes field may be 6N octets in length, where N is the number of services being listed and each listed service occupies 6 octets. Other field lengths may also be used.

FIG. 5 shows various fields in a Probe Request frame, according to an embodiment of the invention. In the illustrated embodiment, the format for these fields is the same as in an association Request frame. However, the Service Hashes field in the Probe Request frame may indicate the services that are being sought by the STA, rather than the services to be provided by the STA which were described in FIG. 4. In some embodiments, the contents of the Attribute ID field may also be different than in FIG. 4.

FIG. 6 shows various fields in a Probe Response frame, according to an embodiment of the invention. In the illustrated example, the various fields shown in the drawing may be located in the Frame Body field of the frame. In this embodiment, the Attribute ID field may indicate that the following fields identify the services that are available through this particular STA. The Length field may be used to find the end of these fields, so that any subsequent data will not be interpreted as part of this service information. For example, the Length field may indicate the length of the Matched Device Descriptors field. The Matched Device Descriptors field may list the services that are both 1) sought after by the STA, and 2) available in the network. In some embodiments, each descriptor may contain a Service ID field to indicate the particular service, and a MAC Address field to indicate the media access control address of the STA that can provide that service. In the illustrated example, the Attribute ID field may be 1 octet in length, the Length field may be 2 octets in length, the Service ID field may be 6 octets in length, the MAC Address field may be 6 octets in length, the Matched Device Descriptors field may be 12N octets in length, where N is the number of services being listed (the number of descriptors) and each listed service occupies 12 octets. The field lengths indicated here are shown as examples, but other field lengths may be used instead.

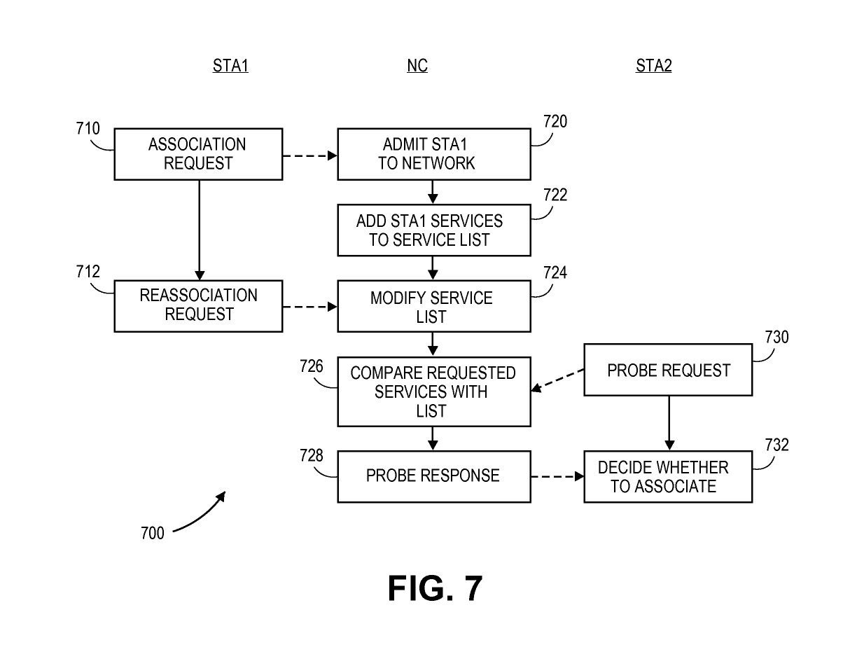

FIG. 7 shows a flow diagram of a method of communicating about services, according to an embodiment of the invention. Flow diagram 700 shows operations for a network controller (NC), a first STA (STA1) that joins the network of the NC, and a second STA (STA) that inquires about the services available in the network of NC. The network may also include other STAs not shown, each of which may perform some or all of the same operations shown for STA1 and/or STA2

When STA1 wants to join (associate with) the NC's network, it may transmit an Association Request to the NC at 710. The Association Request may include a list of services that STA1 can provide to other STAs in the network, once it is part of that network. At 720, the NC may receive that request and admit STA1 to its network through a further series of communications with STA1 (not shown). The NC may also be maintaining a cumulative list of services that STAs in its network can provide. The services indicated in the Association Request from STA1 may be added to that cumulative list at 722.

While STA1 is associated with the network, if the list of services that it can provide changes, at 712 it can notify the NC of the change by transmitting a Reassociation Request containing the updated list. The NC can then modify its cumulative list of services at 724.

In a separate sequence of operations, if STA2 is searching for a network that can provide certain services, STA2 can transmit a Probe Request to the NC at 730. This Probe Request may include a list of services that STA2 is seeking. After receiving the Probe Request, at 726 the NC may compare this list of services being sought by STA2 against the NC's cumulative list of services that are currently provided within the network. The NC may then create a ‘match list’ of the services that were requested by STA2 and are also available in the network. The NC may then insert this match list into a Probe Response and transmit the Probe Response to STA2 at 728.

Based on the match list, STA2 may then decide at 732 whether to associate with the NC. This decision may be based on various factors, such as but not limited to: 1) how many of the requested services are included in the match list, 2) what other networks are available, 3) what services are available from those other networks, 4) etc. If STA2 decides to associate with the network, it may then follow the same operations described for STA1 at 710 and 712, with the same interaction from the NC described at 720, 722, and 724.

The foregoing description is intended to be illustrative and not limiting. Variations will occur to those of skill in the art. Those variations are intended to be included in the various embodiments of the invention, which are limited only by the scope of the following claims.

What is claimed is:

1. A device for communicating wirelessly in a network, the device comprising:
a processor, a memory, and a radio, wherein the device is configured to
communicate a probe request containing a first list of services being sought in a network; and
communicate a probe response containing a second list of services that are both in the first list and available in the network.

2. The device of claim 1, wherein:
said communicating the probe request comprises transmitting the probe request to a network controller; and
said communicating the probe response comprises receiving the probe response from the network controller.

3. The device of claim 1, wherein:
said communicating the probe request comprises receiving the probe request; and
said communicating the probe response comprises transmitting the probe response.

4. The device of claim 1, wherein:
the probe request contains a first identification field, a first length field, and a field containing an indicator for each service in the first list; and
the probe response contains a second identification field, a second length field, and a field containing a descriptor for each service in the second list.

5. The device of claim 4, wherein each descriptor includes a medium access control address for another device able to provide the service identified in the descriptor.

6. A method of communicating in a wireless network, comprising:
communicating a probe request containing a first list of services being sought in the network; and
communicating a probe response containing a second list of services that are both in the first list and available in the network.

7. The method of claim 6, wherein:
said communicating the probe request comprises transmitting the probe request; and
said communicating the probe response comprises receiving the probe response.

8. The method of claim 6, wherein:
said communicating the probe request comprises receiving the probe request; and
said communicating the probe response comprises transmitting the probe response.

9. The method of claim 6, wherein:
the probe request contains a first identification field, a first length field, and a field containing an indicator for each service in the first list; and
the probe response contains a second identification field, a second length field, and a field containing a descriptor for each service in the second list.

10. The method of claim 9, wherein each descriptor includes a medium access control address for another device able to provide the service identified in the descriptor.

11. A computer-readable non-transitory storage medium that contains instructions, which when executed by one or more processors result in performing operations comprising:
communicating a probe request containing a first list of services being sought in a network; and
communicating a probe response containing a second list of services that are both in the first list and available in the network.

12. The medium of claim 11, wherein:
the operation of communicating the probe request comprises transmitting the probe request; and
the operation of communicating the probe response comprises receiving the probe response.

13. The medium of claim 11, wherein:
the operation of communicating the probe request comprises receiving the probe request; and
the operation of communicating the probe response comprises transmitting the probe response.

14. The medium of claim 11, wherein:
the probe request contains a first identification field, a first length field, and a field containing an indicator for each service in the first list; and
the probe response contains a second identification field, a second length field, and a field containing a descriptor for each service in the second list.

15. The medium of claim 14, wherein each descriptor includes a medium access control address for another device able to provide the service identified in the descriptor.

16. A first device for communicating wirelessly in a network, the first device comprising:
a processor, a memory, and a radio;
wherein the first device is configured to communicate a request, the request containing a list of services that can be made available to other devices.

17. The first device of claim 16, wherein:
said communicating the request comprises transmitting the request to a network controller; and
the list of services is a list of services that the first device is capable of providing to the other devices.

18. The first device of claim 16, wherein:
said communicating the request comprises receiving the request; and
the list of services is a list of services that a second device transmitting the request is capable of providing to the other devices.

19. The first device of claim 16, wherein the request comprises one of: 1) an association request, 2) a reassociation request, or 3) an action frame.

20. The first device of claim 19, wherein the request contains an identification field, a length field, and a field containing a separate indicator for each service in the list.

21. A method of communicating in a wireless network, comprising:
wirelessly communicating a request, the request containing a list of services that can be made available to other devices.

22. The method of claim 21, wherein:
said communicating the request comprises transmitting the request to a network controller; and
the list of services is a list of services that a device transmitting the request is capable of providing to the other devices.

23. The method of claim 21, wherein:
said communicating the request comprises receiving the request; and
the list of services is a list of services that a device transmitting the request is capable of providing to the other devices.

24. The method of claim 21, wherein the request comprises one of: 1) an association request, 2) a reassociation request, or 3) an action frame.

25. The method of claim 24, wherein the request contains an identification field, a length field, and a field containing a separate indicator for each service in the list.

26. A computer-readable non-transitory storage medium that contains instructions, which when executed by one or more processors result in performing operations comprising:
wirelessly communicating a request, the request containing a list of services that can be made available to other devices.

27. The medium of claim 26, wherein:
the operation of communicating the request comprises transmitting the request to a network controller; and
the list of services is a list of services that a device transmitting the request is capable of providing to the other devices.

28. The medium of claim 26, wherein:
The operation of communicating the request comprises receiving the request; and
the list of services is a list of services that a device transmitting the request is capable of providing to the other devices.

29. The medium of claim 26, wherein the request comprises one of: 1) an association request, 2) a reassociation request, or 3) an action frame.

30. The medium of claim 29, wherein the request contains an identification field, a length field, and a field containing a separate indicator for each service in the list.
